(19) United States
(12) Patent Application Publication
(10) Pub. No.: US 2009/0132382 A1
(43) Pub. Date: May 21, 2009

(54) SYSTEM AND METHOD OF VIRTUAL PROPERTY TRADING

(75) Inventor: Rocky Mirza, Ottawa (CA)

Correspondence Address: Pearne & Gordon LLP, 1801 East 9th Street, Suite 1200, Cleveland, OH, 44114-3108, US

(73) Assignee: WEBLO, Montreal (CA)

(21) Appl. No.: 11/851,326

(22) Filed: Sep. 6, 2007

(30) Foreign Application Priority Data
Sep. 7, 2006 (CA) 2558904

(51) Int. Cl. G06Q 30/00; G06F 17/30; G06Q 50/00

(52) U.S. Cl. 705/26; 707/100; 707/E17.044

(57) ABSTRACT

A domain name provisioning system and method are provided. The system comprises a domain name repository for storing an association between a virtual domain name and an Internet domain name, and a user interface for allowing Internet users to visit a website associated with the Internet domain name website in response to a request to visit a website associated with the virtual domain name. The method comprises the steps of receiving a request to visit a website associated with a virtual domain name, retrieving an Internet domain name associated with the virtual domain name, and providing a website associated with the Internet domain name in response to the request. A system and method of virtual property trading is also described. The system comprises a user registration component for registering a user with the virtual property system, a user information database for storing user information associated with the registered user, a virtual property database for storing information associated with virtual properties corresponding to real-world properties and a trading component for trading a virtual property between registered users.

### FIELD OF THE INVENTION

The present invention relates to a system and method of trading virtual properties.

### BACKGROUND

An Internet address is a sequence of Domain Name Service (DNS) numbers that uniquely defines a domain on the Internet. A website on a domain may be accessed by entering the Internet address in a text box of a Web browser. In response to receiving the Internet address, the Web browser displays a Web page associated with that Internet address.

The Internet Corporation for Assigned Names and Numbers (ICANN) is an internationally organized, non-profit corporation that has responsibility for Internet Protocol (IP) address space allocation, protocol identifier assignment, generic (gTLD) and country code (ccTLD) Top-Level Domain name system management, and root server system management functions. These services were originally performed under U.S. Government contract by the Internet Assigned Numbers Authority (IANA) and other entities. ICANN now performs the IANA function.

As a private-public partnership, ICANN is dedicated to preserving the operational stability of the Internet; to promoting competition; to achieving broad representation of global Internet communities; and to developing policy appropriate to its mission through bottom-up, consensus-based processes. ICANN is responsible for coordinating the management of the technical elements of the DNS to ensure universal resolvability so that all users of the Internet can find all valid addresses. It does this by overseeing the distribution of unique technical identifiers used in the Internet's operations, and delegation of Top-Level Domain names (such as .com, info, etc.).

A domain name is a name that is assigned to an Internet address such that a person surfing the Web may go to the domain of an entity by entering the domain name in a browser. Domain names are popular as human users of the Internet can associate meaning to a name rather than having to recall a unique sequence of numbers. The Domain Name System (DNS) helps users find their way around the Internet. Every computer on the Internet has a unique address called its “IP address” (Internet Protocol address). Because IP addresses (which are strings of numbers) are hard to remember, the DNS allows a familiar string of letters (the “domain name”) to be used instead. So rather than typing “192.0.34.163,” you can type “www.icann.org.”

The domain name system is managed by the Internet Corporation for Assigned Names and Numbers (ICANN). The Internet Corporation for Assigned Names and Numbers (ICANN) is an internationally organized, non-profit corporation that has responsibility for Internet Protocol (IP) address space allocation, protocol identifier assignment, generic (gTLD) and country code (ccTLD) Top-Level Domain name system management, and root server system management functions. These services were originally performed under U.S. Government contract by the Internet Assigned Numbers Authority (IANA) and other entities. ICANN now performs the IANA function. As a private-public partnership, ICANN is dedicated to preserving the operational stability of the Internet; to promoting competition; to achieving broad representation of global Internet communities; and to developing policy appropriate to its mission through bottom-up, consensus-based processes. ICANN is responsible for coordinating the management of the technical elements of the DNS to ensure universal resolvability so that all users of the Internet can find all valid addresses. It does this by overseeing the distribution of unique technical identifiers used in the Internet's operations, and delegation of Top-Level Domain names (such as .com, .info, etc.).

Each country manages domains within its jurisdiction. To distinguish a domain name of one jurisdiction from that of another, a domain extension is appended the domain name. For example, the extension “.us” is used for the United States, “.ca” is used for Canada and “.uk” is used for the United Kingdom. Such extension are called Top Level Domains (TLD). There are also other common TLDs such as “.com”, “.org”, “.net”, etc. Such TLDs are not necessarily associated with a jurisdiction.

An entity may purchase a domain name on the Internet. An entity may engage the services of a domain name registrar such as domainpeople.com or networksolutions.com. The registrars typically only service a some of the TLDs. For example, domainpeople.com services {.com/.net/.org/.ca/.us/.cn/.biz/.pro/.info/.name/.eu/.de/mobi}, whereas networksolutions.com services {.com/.net/.org/.us/.info/.name/.biz/.de/.tv/.co.uk/cc/.bz}. These registrars will present you with a simple search form where you enter the (2^{nd} level) domain name you wish to register. The domain name can be entered with or without the TLD extension (ex: newdomain or newdomain.com). The registrar then checks the name entered against their local database containing all registered domain names for the respective TLDs that they service.

If the name is available, you then have the option to “add the name to your shopping cart” and also select other available TLD extensions for the same domain name. Some registrars also have a variety of analyzers which may “suggest” a name similar to the name you are searching for when the name is not available. In either case, whenever you wish to register an available name, you simply add it to your shopping cart and then proceed to the checkout.

At the checkout, the entity is required to enter the registrant (owner) information as well as contact info for an administrative contact, a billing contact and a technical contact. Another important requirement is to enter the authoritative name server for the new domain name(s). By default the registrar will assign 2 of its own name servers as the primary and secondary authoritative name servers for the domain.

The authoritative name server determines where the domain name is pointed to. i.e. which IP address to forward requests to for that domain name.

Some jurisdictions have further requirements, especially those that are country specific. For example, to register a .de, the registrar requires a local administrative contact in Germany, even if you do not have a presence in Germany. Other countries may require that you have some legal association with the name within that country, whether it be your company name, personal name, trademark name, etc.

Unfortunately, an entity must purchase the same domain in each jurisdiction in order to obtain world-wide coverage of that domain. This is an onerous task as the entity cannot purchase the domain name in all jurisdictions from one entity.

Sometimes, a person may purchase more than one domain name and forward or redirect traffic to a single domain. Similarly, domain names in a plurality of jurisdictions can be forwarded or redirected to the domain name in a single TLD. Domain forwarding (also called URL redirection) allows you to redirect web requests for your domain name to content hosted on a different server (such as the free web space your ISP may provide). For example, if you have a free website such as “http://users.yourisp.com/˜yourusername” you can register another domain name (www.your-name.com) and forward that URL of your free site. This kind of redirection is usually done at the application level. The entity would encode their index page, or several pages with an http redirect (HTML) statement to redirect the page to the new domain name. The encoding can also be masked so that domain name (www.Your-name.com) is always seen in the browser location bar instead of the address of the free site which is actually serving the content.

Another form redirection is from one domain name to the other. For example, the user may enter “www.domain.com” but it will show up in the browser as “domain.go.com”. This kind of redirection can be done at the application level as described above and also at the server level. At the server level, the entity would simply need to define a virtual domain for disney.com and another for disney.go.com on the web server. In the scope of a web server, if the web server hosts multiple domains under the same IP address, these domains are referred to as virtual domains.

When a domain or virtual domain is defined on a web server, you must also define the document root which is basically the folder where the web documents (to be seen on the web site) reside for that domain. One could simply configure the web server to point both virtual domains to the same folder, thus disney.com and disney.go.com actually have the same content. This method also requires coordination from the respective authoritative name servers of each domain. Both domain names must be registered in the name server(s) to point to the same IP address (same web server) for this method to work.

If an entity wishes to change where a domain name is forwarded or redirected, the DNS servers would have to be updated. Such updating is performed automatically after the initial update by the domain's authorized personnel. In order for every user of the Internet to be aware of the update to the forwarding or redirecting of the domain name, every DNS server around the world would have to be updated. Such an onerous amount of updating will take time. With the current amount of DNS servers worldwide, it is estimated that it would take approximately up to 48 hours to update all DNS servers around the world with the new forwarded or redirected domain entry. Such time constraint can be costly for an entity that needs to have its domain forwarded or redirected as soon as possible.

Each domain registered on a name server is controlled by what is called a zone file. The zone typically defines the Internet space for that domain. Within the zone file, there are definitions pertaining to that zone “domain” such as the name server record, mail exchanger record, address record, time to live settings, expiry dates, sub-domain definitions, etc. The address record (known as the A record) defines which IP address the domain name should point to.

If an entity wishes to change where their domain name is pointed (forwarded) to, they simple need to edit the zone file for that domain. As this file is quite sensitive, only qualified personnel are allowed to change the file. However, some hosting companies now have software that will allow the end-user to edit their zone file without causing too much of a havoc. Generally, zone file edits are still performed by the hosting company personnel and can take anywhere from 2 hours to 48 hours to complete. Once the changes are complete and have been saved to the database, it will take another 2 to 48 hours for all the names servers on the Internet to be updated.

An entity may register its domain on a directory. Other ways for Internet users to find an entity's domain include trial and error and the use of search engines. Search engines have programmed software called spiders that search the Internet for key words on websites in the form of metadata. A user of a search engine would simply have to enter the key words (i.e., search terms) in a text box of the search engine Web page. Some search engines also allow for website addresses to be inserted as a search term. Results of a search engine search, or a directory search, are displayed to the user in a list of website links. The user can then select or browse a website link.

Most of the generic domain names have been assigned. There is no way for a generic domain name to be reused in the same jurisdiction (i.e., TLD) by different entities. It is desirable to have a more flexible and robust way of provisioning domain names.

### SUMMARY OF THE INVENTION

In accordance with an embodiment of the present invention, there is provided a domain name provisioning system. The system comprises a domain name repository for storing an association between a virtual domain name and an Internet domain name, and a user interface for allowing Internet users to visit a website associated with the Internet domain name website in response to a request to visit a website associated with the virtual domain name.

In accordance with another embodiment of the present invention, there is provided a method of domain name provisioning. The method comprises the steps of receiving a request to visit a website associated with a virtual domain name, retrieving an Internet domain name associated with the virtual domain name, and providing a website associated with the Internet domain name in response to the request.

In accordance with another embodiment of the present invention, there is provided a virtual property trading system comprising a user registration component for registering a user with the virtual property system, a user information database for storing user information associated with the registered user, a virtual property database for storing information associated with virtual properties corresponding to real-world properties and a trading component for trading a virtual property between registered users.

In accordance with another embodiment of the present invention, there is provided a method of trading virtual property. The method comprises registering a user with a virtual property trading system, storing user information associated with the registered user, storing information associated with virtual properties corresponding to real-world properties and trading a virtual property between registered users.

### BRIEF DESCRIPTION OF THE DRAWINGS

An embodiment of the present invention will now be described by way of example only with reference to the following drawings in which:

FIG. 1 shows in a component diagram an example of a domain name provisioning system, in accordance with an embodiment of the present invention;

FIG. 2 shows in a flowchart an example of a method of domain name provisioning, in accordance with an embodiment of the domain name provisioning system;

FIG. 3 shows in a component diagram another example of a domain name provisioning system, in accordance with an embodiment of the present invention;

FIG. 4 shows in a flowchart an example of a method of generating a domain name association, in accordance with an embodiment of the domain name provisioning system;

FIG. 5 shows in a flowchart another method of changing a domain name association, in accordance with an embodiment of the domain name provisioning system;

FIG. 6 shows in a component diagram an example of a virtual domain provisioning system, in accordance with an embodiment of the domain name provisioning system;

FIG. 7 shows in a component diagram an example of a virtual property system;

FIG. 8 shows in a component diagram an example of virtual property creation components, in accordance with an embodiment of the domain name provisioning system.

### DETAILED DESCRIPTION OF THE PREFERRED EMBODIMENTS

A system and method of the present invention will now be described with reference to various examples of how the embodiments can best be made and used. For convenience, like reference numerals are used throughout the description and several views of the drawings to indicate like or corresponding parts, wherein the various elements are not necessarily drawn to scale.

FIG. 1 shows in a component diagram an example of a domain name provisioning system 100, in accordance with an embodiment of the present invention. The domain name provisioning system comprises a domain name repository 102 for storing an association between a virtual domain name and an Internet domain name, and a user interface 104 for allowing Internet users to visit a website associated with the Internet domain name website in response to a request to visit a website associated with the virtual domain name. Thus, when a user accesses the user interface 104 and requests the virtual domain, the system 100 searches the domain name repository 102 to locates the Internet domain name associated with the virtual domain name and directs or forwards the user to the associated Internet domain. Other components may be added to the domain name provisioning system, such as a virtual domain assignor for associating an Internet domain name with a virtual domain name, an entity interface for allowing entities to order or purchase virtual domain names, a domain name analyser for determining if a virtual domain is available or if an Internet domain name is prohibited or blocked from being associated to a virtual domain, a repository of unavailable virtual domains or blocked Internet domains, and a payment module for collecting funds for the purchase of virtual domain names. A plurality of domain name associations (i.e., associations between virtual domain names and Internet domain names) can be stored in the repository.

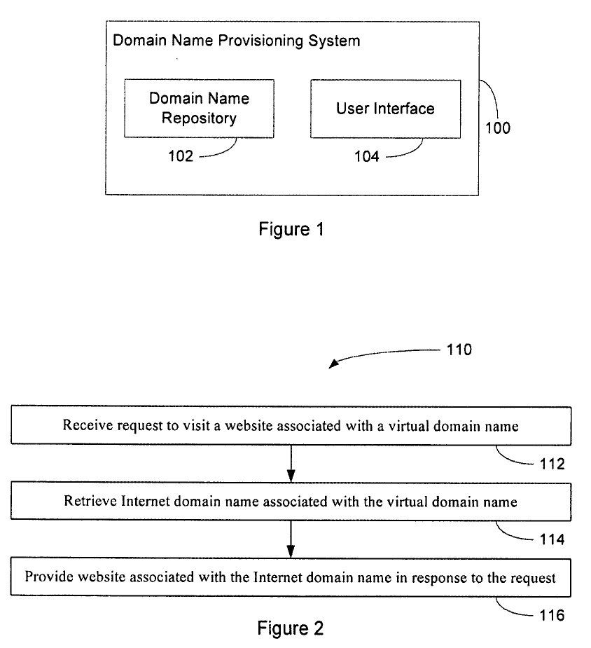

FIG. 2 shows in a flowchart an example of a method of domain name provisioning (110), in accordance with an embodiment of the domain name provisioning system 100. The method (110) begins with receiving a request to visit a website associated with a virtual domain name (112). Next, an Internet domain name associated with the virtual domain name is retrieved (114). A website associated with the Internet domain name is provided in response to the request (116). Other steps may be added to the method, including storing domain name associations, associating an Internet domain name with a virtual domain name, allowing entities to order or purchase virtual domain names, determining if a virtual domain is available or if an Internet domain name is prohibited or blocked from being associated to a virtual domain, storing unavailable virtual domains or blocked Internet domains, and collecting payment for the purchase of virtual domain names.

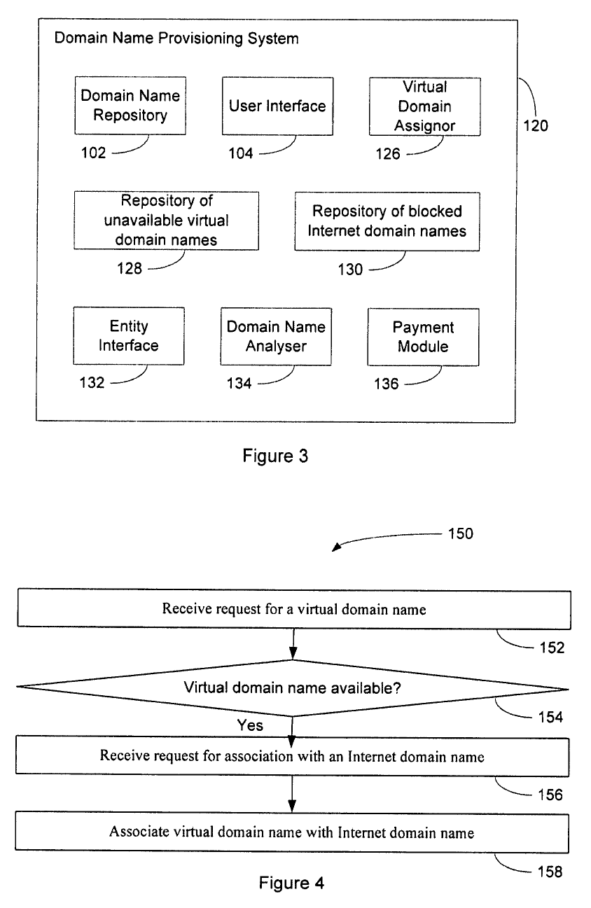

FIG. 3 shows in a component diagram another example of a domain name provisioning system 120, in accordance with an embodiment of the present invention. The domain name system 120 comprises the domain name repository 102, the user interface 104, a virtual domain assignor 126 for associating an Internet domain name with a virtual domain name, a repository of unavailable virtual domain names 128 or blocked Internet domain names 130, an entity interface 132 for allowing entities to order or purchase virtual domain names, a domain name analyser 134 for determining if a virtual domain is available or if an Internet domain name is prohibited or blocked from being associated to a virtual domain, and a payment module 136 for collecting funds for the purchase of virtual domain names.

A virtual domain name can be associated with any Internet domain name, but only one at a time. The virtual domain assigner 126 can be used to add, remove or modify domain name associations from the domain name repository 102. A listing of used virtual domain names can be kept to prevent an entity from ordering or purchasing a virtual domain name that has been taken. The listing of used virtual domain names can be kept in a separate repository 128 or in a table of the domain name repository 102.

There may also be situations where an Internet domain name may not be available or is prohibited from being associated to a virtual domain. A listing of prohibited or blocked Internet domain names can be kept to prevent a user from being directed to prohibited or blocked Internet domain names. The listing of prohibited or blocked Internet domain names can be kept in a separate repository 130 or in a table of the domain name repository 102.

The entity interface 132 is used to allow entities to order virtual domain names. The domain name analyser 134 can determine if a requested domain is available or blocked by searching the repositories 132, 134. The payment module 136 allows for electronic commerce with respect to the purchase and sale of virtual domain names.

FIG. 4 shows in a flowchart an example of a method of generating a domain name association (150), in accordance with an embodiment of the domain name provisioning system 120. The method (150) begins with receiving a request for a virtual domain name (152). If the virtual domain name is available (154), then a request for an association with an Internet domain name is received (156). The virtual domain name is associated with the Internet domain name (158) by storing a domain name association in the repository 102. A user may now request the virtual domain name. Other steps may be added to the method (150), including receiving electronic payment for the virtual domain name. Advantageously, a plurality of TLDs for the virtual domain name can be associated to the same Internet domain name, provided that the virtual domain name for each TLD is available.

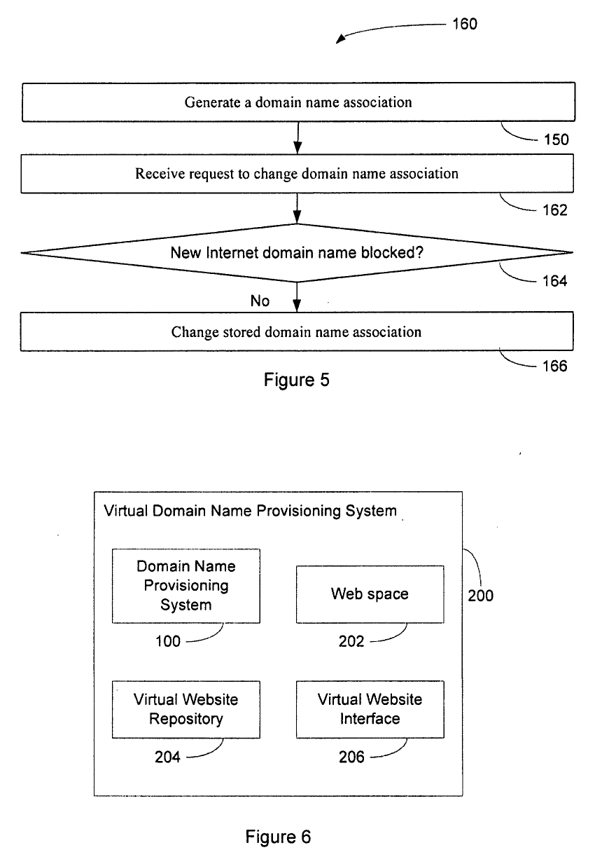

FIG. 5 shows in a flowchart another method of changing a domain name association (160), in accordance with an embodiment of the domain name provisioning system 120. The method (160) begins with generating a domain name association (150).

Next, a request is received to change the domain name association (162). If the new Internet domain name is not blocked (164), then the stored domain name association is changed so that the virtual domain name is now associated with the new Internet domain name (166). A user requesting the virtual domain will now be directed to the new Internet domain.

The domain name provisioning system 100, 120, may also include Web space hosting functionality to allow an entity to create a virtual website associate with the virtual domain name. Such virtual website may be located in an Internet Service Provider domain or Web Space Provider domain.

FIG. 6 shows in a component diagram an example of a virtual domain provisioning system 200, in accordance with an embodiment of the domain name provisioning system 100. The virtual domain provisioning system 200 comprises the domain name provisioning system 100 for associating a virtual domain name with an Internet domain name, Web space 202 for hosting a virtual website, a virtual website repository 204 for storing an association between the virtual domain name and a website file of the virtual website hosted on the Web space 202, and a virtual website interface 206 for allowing a user to select between the virtual website and a website associated with the Internet domain name. Other components may be added to the virtual domain provisioning system 200.

The virtual domain provisioning system 200 can be extended to include components for associating a system user with a virtual property corresponding to a real-world property. For example, a real world province or city may correspond to a virtual province or city and this virtual property may be associated with a system user. This association may be used, for example, to allow a user to purchase virtual property.

As described above, this property may correspond to real world real-estate, such as houses, buildings, parks, cities, towns, provinces and countries. Additionally, the virtual property may be associated with real-world people, for example, sports athletes, actors, etc. Once a user has been associated with a virtual property that corresponds to real world property, the user can create and associate a web site with the property.

The system may include a user registration component for registering users that can then be associated with virtual properties. Although it is intended that the system associate one user with a particular virtual property, the system may associate multiple virtual properties with a user.

The system may also comprise a tracking component. The tracking component may track the amount of traffic going to the web sites associated with the virtual properties. The system may also comprise a trading component for buying selling or trading virtual properties. The trading component may allow a user associated with a virtual property to determine a price to sell a virtual property at. If the asking price is met by another user, the trading component can then associate the sold virtual property with the new user. Additionally or alternatively, the trading component can be used to allow a user to offer to purchase a virtual property from the owner associated with the virtual property.

In addition to the user registration component, the system may include a user information component for maintaining user information. This user information may include information such as the virtual properties currently associated with a user, the user's name etc. The information may also comprise an indication of the amount of credits or money currently associated with the user. These credits or money can be added through a transaction component. The transaction component may allow a user to purchase credits or money using real-world money. The purchased credits or money can then be used to purchase virtual properties, such as virtual real estate, virtual personalities, or virtual web sites. The credits can be transferred between users when trading or purchasing virtual properties.

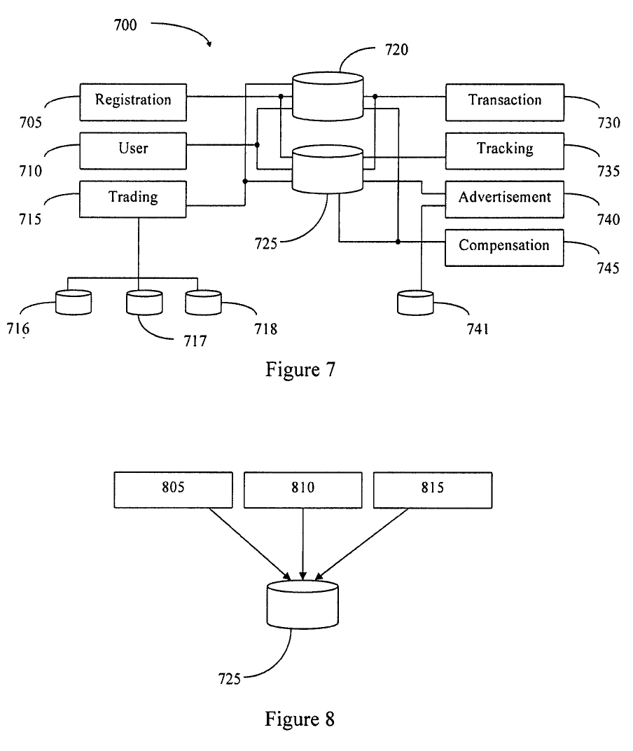

FIG. 7 shows in a component diagram an example of a virtual property system 700. The system may comprise a user registration component 705, a user information component 710, a trading component 715, a user information database 720, a virtual property database 725, a transaction component 730, a tracking component 735, an advertisement component 740, and a compensation component 745.

The user registration component 705 allows a user to register with the system and input the user information. This information may be stored in the user information database 720. The user information component 710 allows a user to change or modify the information stored in the user information database 720.

The transaction component 730 can be used to allow a user to purchase credits or money from the real world to purchase virtual properties within the system 700. The association of virtual properties can be maintained in the user information database 720. Additionally or alternatively this association information may be stored in the virtual property database 725.

The virtual property database 725 may store information on all virtual properties that are part of the system. As previously described, these virtual properties correspond to real world properties, as such there is a limited number of virtual properties available in the system 700. The trading component 715 allows users registered with the system to purchase, buy, sell or trade virtual properties with other users. The trading component 715 may check with databases to determine what virtual properties are currently being sold. For example, databases 716, 717 and 718 may each store information on the virtual web sites, virtual people, and virtual real-estate for sale.

The virtual property database 725 may include a web site associated with a virtual property. The user associated with a virtual property (the virtual property owner) may create this web site. As with the virtual domain name provisioning system, the web site may be an web site internal to the system 700, or it may be a web site on a portion of the Internet external to the system 700.

The system 700 may track the traffic going to the web sites for virtual properties. The tracking component 735 may be used to perform this tracking. The information may be stored within the virtual property database 725. This information may be viewed by other users.

The tracking information may be used by an advertising component 740. The advertising component 740 can insert advertisements into the web pages associated with virtual properties. The advertisements may be based on the amount of traffic generated by web sites. The advertisements and the rules for associating them with web pages, for example the minimum traffic necessary for a web page to use an advertisement, may be stored in a database 741.

The system 700 may include a compensation component 745. The compensation component 745 may provide credits or money to users based on the advertisements displayed on web sites of the users' virtual properties. The amount of compensation for a particular virtual property may be stored within the virtual property database 725. Other users may view this compensation information when purchasing a virtual property.

The correspondence between virtual properties and the real-world properties creates a demand within the system 700. This demand encourages the users to trade their virtual properties to make a profit (i.e. sell a virtual property for more then it was purchased). A user may increase the worth of a virtual property by increasing the amount of traffic to the associated web site, thereby increasing the compensation amount, and so the potential amount a new user may be willing to pay for the virtual property. The virtual property system may be used as a virtual property trading system.

Additionally, the compensation component may also compensate a virtual property based on other factors. For example, a virtual property that is a province may receive a compensation for the virtual properties that are sold within the province.

FIG. 8 shows in a component diagram an example of a virtual property creation components that can be used in accordance with the virtual property trading system. The virtual properties disclosed above may be traded between users. The virtual property trading system may comprise components for creating the virtual components.

The virtual personality creator component 805 may comprise functionality for creating a virtual property representation of a real-world personality. The created virtual personality may then be stored in the virtual property database 725. The creation of virtual personalities may be based on a user entering a person's name and checking to see if the name already exists. The virtual personality creator may be more complex, for example, two virtual personalities may share the same name, but may be related to different areas, for example one name may be for an actor, while another virtual personality of the same name is for an athlete. The virtual personality creator accepts enough information to uniquely identify the real-world personality.

The virtual property trading system may also include a virtual real-estate creator 810 for creating a virtual real-estate that corresponds to real-world real estate. The created virtual real-estate representation may be stored in the virtual property database 725. The creation of the virtual real-estate may use a listing of real-world address, real-world buildings etc. It may use a search of known repositories (for example postal code listings etc) to identify the real-world real-estate.

The virtual domain creator 815 may include for example, the virtual domain name provisioning system described above. The virtual domain name provisioning system may save the domain name associations (of the virtual domain names that are not already taken or are on a blocked list) in the virtual property database 725.

The systems and methods according to the present invention may be implemented by any hardware, software or a combination of hardware and software having the above described functions. The software code, either in its entirety or a part thereof, may be stored in a computer-readable memory. Further, a computer data signal representing the software code which may be embedded in a carrier wave may be transmitted via a communication network. Such a computer-readable memory and a computer data signal are also within the scope of the present patent disclosure, as well as the hardware, software and the combination thereof.

While particular embodiments of the present invention have been shown and described, changes and modifications may be made to such embodiments without departing from the true scope of the invention.

What is claimed is:

1. A domain name provisioning system comprising:
a domain name repository for storing an association between a virtual domain name and an Internet domain name; and
a user interface for allowing Internet users to visit a website associated with the Internet domain name website in response to a request to visit a website associated with the virtual domain name.

2. The domain name system as claimed in claim 1, further comprising a virtual domain assignor for associating an Internet domain name with a virtual domain name.

3. The domain name system as claimed in claim 1, further comprising a repository of unavailable virtual domain names or blocked Internet domain names.

4. The domain name system as claimed in claim 1, further comprising an entity interface for allowing entities to order or purchase virtual domain names.

5. The domain name system as claimed in claim 1, further comprising a domain name analyser for determining if a virtual domain is available or if an Internet domain name is prohibited or blocked from being associated to a virtual domain.

6. The domain name system as claimed in claim 1, further comprising a payment module for collecting funds for the purchase of virtual domain names.

7. The domain name system as claimed in claim 1, further comprising:
Web space for hosting a virtual website;
a virtual website repository for storing an association between the virtual domain name and a website file of the virtual website hosted on the Web space; and
a virtual website interface for allowing a user to select between the virtual website and a website associated with the Internet domain name.

8. A method of domain name provisioning, the method comprising the steps of:
receiving a request to visit a website associated with a virtual domain name;
retrieving an Internet domain name associated with the virtual domain name; and
providing a website associated with the Internet domain name in response to the request.

9. The method as claimed in claim 8, further comprising the step of storing domain name associations in a repository.

10. The method as claimed in claim 8, further comprising the step of associating an Internet domain name with a virtual domain name.

11. The method as claimed in claim 8, further comprising the step of allowing entities to order or purchase virtual domain names.

12. The method as claimed in claim 8, further comprising the step of determining if a virtual domain is available or if an Internet domain name is prohibited or blocked from being associated to a virtual domain.

13. The method as claimed in claim 8, further comprising the step of storing unavailable virtual domains or blocked Internet domains in a repository.

14. The method as claimed in claim 8, further comprising the step of collecting payment for the purchase of virtual domain names.

15. A virtual property trading system comprising:
a user registration component for registering a user with the virtual property system;
a user information database for storing user information associated with the registered user;
a virtual property database for storing information associated with virtual properties corresponding to real-world properties; and
a trading component for trading a virtual property between registered users.

16. The virtual property trading system as claimed in claim 15, wherein the user information stored in the user information database includes information identifying the virtual properties associated with the user.

17. The virtual property trading system as claimed in claim 1S, wherein the virtual property information stored in the virtual property database includes information identifying the user associated with virtual properties.

18. The virtual property trading system as claimed in claim 15, wherein the user information includes money information for indicating the amount of money associated with a user.

19. The virtual property trading system as claimed in claim 18, wherein the trading of virtual property between registered users includes the transfer of money between the registered users.

20. The virtual property trading system as claimed in claim 15, further comprising a transaction component for allowing a registered user to associate money with their account by charging a real-world account.

21. The virtual property trading system as claimed in claim 15, wherein the virtual properties are associated with a web page within the virtual property trading system.

22. The virtual property trading system as claimed in claim 21, further comprising a tracking component for tracking the amount of traffic to the web page within the virtual property trading system and saving the information in the virtual property database.

23. The virtual property trading system as claimed in claim 22, further comprising an advertising component for placing advertisements on a web page within the virtual property trading system.

24. The virtual property trading system as claimed in claim 23, further comprising a compensation component for associating money with a user based on the advertisements placed on web pages within the virtual property trading system, wherein the web pages are associated with virtual properties associated with the user.

25. A method of trading virtual property comprising:
registering a user with a virtual property trading system;
storing user information associated with the registered user;
storing information associated with virtual properties corresponding to real-world properties; and
trading a virtual property between registered users.

26. A computer-readable medium storing instructions or statements for use in the execution in a computer of a method of trading virtual property, the method comprising the steps of:
registering a user with a virtual property trading system;
storing user information associated with the registered user;
storing information associated with virtual properties corresponding to real-world properties; and
trading a virtual property between registered users.

27. A propagated signal carrier carrying signals containing computer-executable instructions that can be read and executed by a computer, the computer-executable instructions being used to execute a method of trading virtual property, the method comprising the steps of:
registering a user with a virtual property trading system;
storing user information associated with the registered user;
storing information associated with virtual properties corresponding to real-world properties; and
trading a virtual property between registered users.
